(19) United States
(12) Patent Application Publication
(10) Pub. No.: US 2021/0294312 A1
(43) Pub. Date: Sep. 23, 2021

(54) QUALITY STABILIZATION SYSTEM, QUALITY STABILIZATION METHOD, AND NON-TRANSITORY COMPUTER READABLE STORAGE MEDIUM

(71) Applicant: Yokogawa Electric Corporation, Tokyo (JP)

(72) Inventors: Masayasu OHASHI, Tokyo (JP); Nobuaki EMA, Tokyo (JP); Yoshitaka YOSHIDA, Tokyo (JP)

(21) Appl. No.: 17/158,467

(22) Filed: Jan. 26, 2021

(30) Foreign Application Priority Data
Mar. 17, 2020 (JP) 2020-046357

(51) Int. Cl. G05B 19/418

(52) U.S. Cl. CPC G05B 19/41875; G05B 19/4185; G05B 19/41845; G05B 19/41835

(57) ABSTRACT

A quality stabilization system stabilizes quality of a third product to be produced in an industrial process having a first production process, a second production process, and a third production process which are independent of each other. A first product is produced in the first production process. A second product is produced in the second production process. The third product is produced using the first product and the second product in the third production process. The quality stabilization system includes a collector configured to collect evaluation indices for evaluating qualities of the first product produced in the first production process and the second product produced in the second production process, a selector configured to select at least one of the first production process, the second production process, and the third production process in accordance with the evaluation indices collected by the collector, and an adjuster configured to adjust the quality of a product which is produced in a production process selected by the selector.

### BACKGROUND

### Technical Fields

The present invention relates to a quality stabilization system, a quality stabilization method, and a non-transitory computer readable storage medium for stabilizing the quality of a product.

Priority is claimed on Japanese Patent Application No. 2020-046357, filed on Mar. 17, 2020, the contents of which are incorporated herein by reference.

### Description of Related Art

Conventionally, production agement systems such as process control systems have been constructed at production sites such as plants and factories and advanced automated operations have been implemented. In a conventional production management system, the quality of a product is ensured by setting conditions for production factors (factors for producing a certain product) on the basis of science technology and production technology established in a laboratory and maintaining the set conditions. Here, among the above-described production factors, materials (Material), facilities (Machine), processes (Method), and persons (huMan) are referred to as “four factors of production.” The “four factors of production” are sometimes referred to as 4M.

Japanese Unexamined Patent Application Publication No. 2016-177794 discloses a technology for identifying obstructive factors that cause non-uniformity in product performance and stabilizing product performance and manufacturing performance. Specifically, in the technology disclosed in Japanese Unexamined Patent Application Publication No. 2016-177794, the product performance and the manufacturing performance are stabilized by dividing manufacturing process lots into a plurality of groups from principal component scores generated on the basis of process data, determining the superiority or inferiority of the plurality of groups on the basis of product data, and identifying the obstructive factors that contribute to the superiority or inferiority of the group.

Incidentally, when a final product is produced by sequentially executing a plurality of production processes in series, the quality of the final product can be stabilized by performing the production while minimizing the variation in quality in each production process. However, when a final product is produced by combining a plurality of products (intermediate products) produced through production processes independent of each other, there is a problem that the quality of the final product may not be sufficiently stabilized, for example, even if the qualities of the intermediate products are stable.

### SUMMARY

A quality stabilization system stabilizes quality of a third product to be produced in an industrial process having a first production process, a second production process, and a third production process which are independent of each other. A first product is produced in the first production process. A second product is produced in the second production process. The third product is produced using the first product and the second product in the third production process. The quality stabilization system includes a collector configured to collect evaluation indices for evaluating qualities of the first product produced in the first production process and the second product produced in the second production process, a selector configured to select at least one of the first production process, the second production process, and the third production process in accordance with the evaluation indices collected by the collector, and an adjuster configured to adjust the quality of a product which is produced in a production process selected by the selector.

Further features and aspects of the present disclosure will become apparent from the following detailed description of exemplary embodiments with reference to the attached drawings.

### BRIEF DESCRIPTION OF THE DRAWINGS

FIG. 1 is a block diagram showing a main configuration of a quality stabilization system according to a first embodiment of the present invention.

FIG. 2 is a diagram showing an example of production processes provided in an industrial process according to the first embodiment of the present invention.

FIG. 3 is a diagram conceptually showing adjustment performed according to an instruction of an adjustment instructor in the first embodiment of the present invention.

FIG. 4 is a flowchart showing a quality stabilization method according to the first embodiment of the present invention.

FIG. 5 is a block diagram showing a main configuration of a quality stabilization system according to a second embodiment of the present invention.

FIG. 6A is a diagram for describing auxiliary information used in the second embodiment of the present invention.

FIG. 6B is a diagram for describing auxiliary information used in the second embodiment of the present invention.

FIG. 6C is a diagram for describing auxiliary information used in the second embodiment of the present invention.

FIG. 7 is a diagram showing an example of production processes provided in an industrial process according to a third embodiment of the present invention.

FIG. 8 is a block diagram showing an implementation example of a quality stabilization system according to an embodiment of the present invention.

### DETAILED DESCRIPTION OF THE INVENTION

The embodiments of the present invention will be now described herein with reference to illustrative preferred embodiments. Those skilled in the art will recognize that many alternative preferred embodiments can be accomplished using the teaching of the present invention and that the present invention is not limited to the preferred embodiments illustrated herein for explanatory purposes.

An aspect of the present invention is to provide a quality stabilization system, a quality stabilization method, and a non-transitory computer readable storage medium capable of stabilizing the quality of a product to be produced by combining a plurality of products produced through production processes independent of each other.

Hereinafter, a quality stabilization system, a quality stabilization method, and a quality stabilization program according to embodiments of the present invention will be described in detail with reference to the drawings. Hereinafter, an overview of the embodiments of the present invention will be described first and then details of the embodiments of the present invention will be described.

### [Overview]

The embodiments of the present invention are intended to stabilize the quality of a product to be produced by combining a plurality of products produced through production processes independent of each other. Here, the environment confining production industries at present includes intensifying global competition, fluctuations in energy and material costs, a decrease in the number of workers, an aging population, diversification of supply chains independent of affiliates, and the like. Under such an environment, the following situations are occurring at production sites.
The quality of materials is not necessarily uniform (Material)
The deterioration of facilities over time is in progress (Machine)
Staff members begin to face process-related problems that have not been manifested so far (Method)
In terms of personnel, the number of veterans is decreasing and operating know-how is also being lost (huMan).

That is, the production sites are in a situation in which products need to be produced with personnel who lack know-how and experience, using materials with varying quality and a production facility that has deteriorated over time. Moreover, because products of higher quality than before are required, it is necessary to provide products differentiated with higher quality than ever before. Thus, it can be said that the current situation is that a significantly large amount of labor is being imposed on the production sites.

In this situation, when a product is produced by a production process group including a plurality of production processes to be sequentially executed in series, a product produced in a previous production process included in the production process group is used as a material for a subsequent production process in the production process group. Thus, it is possible to stabilize the quality of a final product by performing the production while minimizing the variation in quality in each production process included in the production process group.

However, when a final product is produced by combining a plurality of products (intermediate products) produced through production processes independent of each other, there is a problem that the quality of the final product may not be able to be sufficiently stabilized. For example, when a first product and a second product are produced in a first production process and a second production process independent of each other and a third product is produced using the first product anti the second product, it may not be possible to sufficiently stabilize the quality of the third product.

Also, this is true for a case in which each of the above-described first and second production processes includes a production process group including a plurality of production processes to be sequentially executed in series. In this case, the production can be performed while minimizing the variation in quality in the production process group included in the first production process, so that the quality of the first product can be stabilized. Also, because it is also possible to perform the production in the production process group included in the second production process while minimizing the variation in quality, the quality of the second product can be stabilized. However, even if the qualities of the first product and the second product are stable, the quality of the third product to be produced using the first product and the second product may not be sufficiently stabilized.

In the embodiment of the present invention, each of evaluation indices for evaluating qualities of the first product produced in the first production process and the second product produced in the second production process is first collected. Next, at least one of the first production process, the second production process, and the third production process of producing the third product using the first product and the second product is selected in accordance with the evaluation indices that have been collected and the quality of the product to be produced in the selected production process is adjusted. Thereby, it is possible to stabilize the quality of a product (the third product) to be produced by combining a plurality of products (the first product and the second product) produced through production processes independent of each other.

### [First Embodiment]

### <Quality Stabilization System>

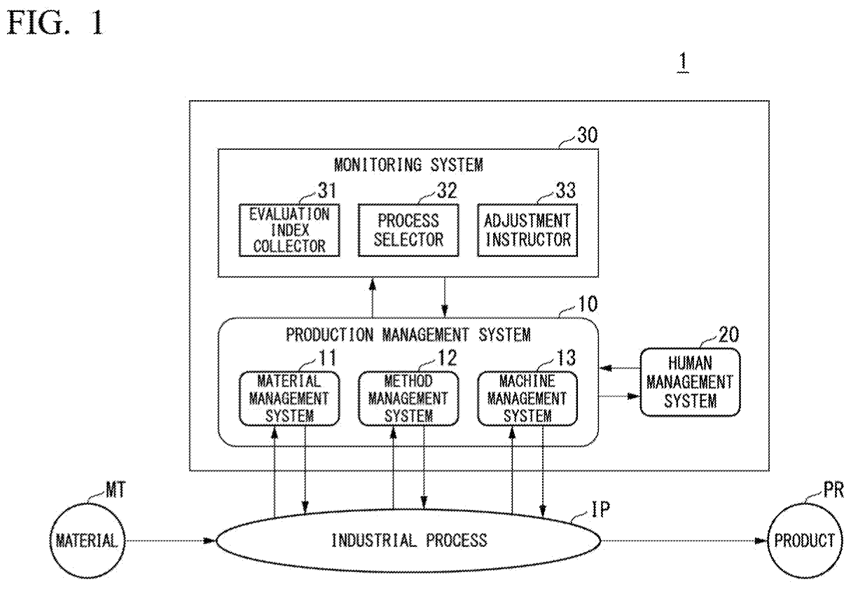

FIG. 1 is a block diagram showing a main configuration of a quality stabilization system according to a first embodiment of the present invention. As shown in FIG. 1, the quality stabilization system 1 of the present embodiment includes a production management system 10, a human management system 20, and a monitoring system 30 and is a system for stabilizing the quality of a product PR to be produced (manufactured) in an industrial process IP.

Here, the industrial process IP that is a control target of the quality stabilization system I will be described before description of details of the quality stabilization system 1. The industrial process IP includes various types of facilities (for example, piping, valves, pumps, reactors, tanks, and the like) necessary for producing the product PR from material MT and the product PR is produced from the material MT according to control of the production management system 10.

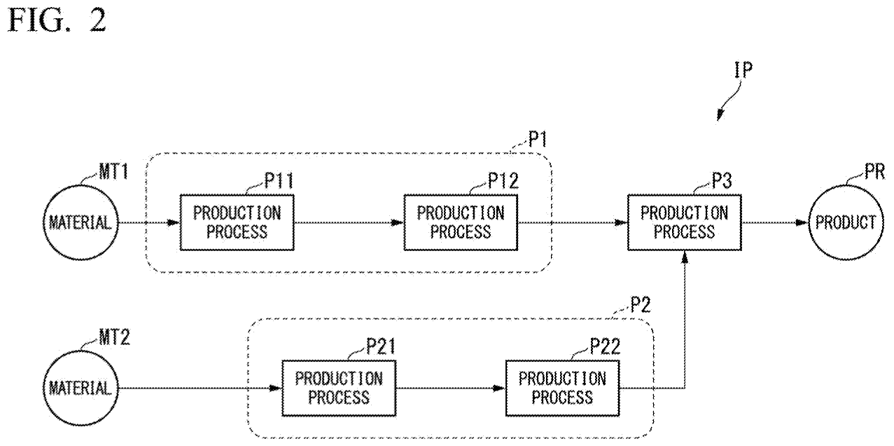

FIG. 2 is a diagram showing an example of production processes included in the industrial process according to the first embodiment of the present invention. The industrial process IP in the example shown in FIG. 2 has a production process P1 (a first production process), a production process P2 (a second production process), and a production process P3 (a third production process). In the industrial process IP, the product PR (the third product) is produced from materials MT1 and MT2 serving as the material MT. The horizontal direction of the paper surface in FIG. 2 represents a time position.

The production process P1 has production processes P11 and P12 (a production process group) to be sequentially executed in series and is a process of producing an intermediate product (the first product) from the material MT1. The production process P2 has production processes P21 and P22 (a production process group) to be sequentially executed in series and is a process of producing an intermediate product (the second product) from the material MT2. In the production processes P1 and P2, intermediate products are produced independently of each other. The production process P3 is a process of producing the product PR using the intermediate products produced independently of each other in the production processes P1 and P2.

As shown in FIG. 2, the production process P21 included in the production process P2 is performed between the production process P11 and the production process P12 included in the production process P1. Also, the production process P22 included in the production process P2 is performed between the production process P12 included in the production process P1 and the production process P3. That is, in the industrial process IP shown in FIG. 2, the production process P11 included in the production process P1, the production process P21 included in the production process P2, the production process P12 included in the production process P1, the production process P22 included in the production process P2, and the production process P3 are sequentially performed.

The production management system 10 controls production factors of the product PR to be produced in the industrial process IP. Specifically, the production management system 10 collects operation data, which is data related to a plurality of production factors of the product PR produced in the industrial process IP, generates an evaluation index for use in evaluating the quality of the product PR, and outputs the evaluation index to the monitoring system 30. The above-described evaluation index is also referred to as a key performance indicator (KPI). Also, the production management system 10 controls a plurality of production factors of the product PR to be produced in the industrial process IP on the basis of an instruction from the monitoring system 30.

The production management system 10 includes a material management system 11, a method management system 12, and a machine management system 13. The material management system 11 controls a “material” among the “four factors of production.” The control of the “material” by the material management system 11 can be performed in any method. For example, the material management system 11 may perform control for changing a mixing proportion (a blending proportion) of the material MT for use in the industrial process IP. The material management system 11 generates an evaluation index regarding the “material” (hereinafter referred to as a “material evaluation index”) and outputs the material evaluation index to the monitoring system 30.

The method management system 12 controls a “process” among the “four factors of production.” For example, the method management system 12 includes a controller provided in a process control apparatus such as a distributed control system (DCS). For example, the method management system 12 controls the “process” by controlling an actuator (a field device) installed at a plant site in accordance with a measurement result of the sensor (a field device) installed at the plant site. The method management system 12 generates an evaluation index regarding the “process” (hereinafter referred to as a “process evaluation index”) and outputs the process evaluation index to the monitoring system 30.

The machine management system 13 controls “facility” among the “four factors of production.” The “facility” can be controlled by the machine management system 13 in any method. For example, when a cleaning function is provided in the facility used in the industrial process IP, the machine management system 13 may be configured to maintain uniform facility capability (or to recover from the deterioration of facility capability caused due to contamination of facility) by performing control for operating the cleaning function, providing a notification for requesting a maintenance staff member to perform cleaning, or the like. Also, the machine management system 13 may control a lubrication interval of a drive system of the facility, a change in a parameter depending on an aging condition of the facility, and the like to maintain the uniform facility capability. The machine management system 13 generates an evaluation index regarding the “facility” (hereinafter referred to as a “facility evaluation index”) and outputs the evaluation index to the monitoring system 30.

The human management system 20 controls “personnel” among the “four factors of production.” The control of the “personnel” by the human management system 20 can be performed in any method according to experience, skills, work styles, and the like of the “personnel.” For example, the human management system 20 may be configured to perform scheduling for workers with low skills to be accompanied by workers with high skills as assistants so that the skills do not vary from worker to worker. Also, the human management system 20 may control an operation timing of the worker, a change in the work order, and the like. The human management system 20 generates an evaluation index regarding the “personnel” (hereinafter referred to as a “personnel evaluation index”) and outputs the personnel evaluation index to the monitoring system 30 via the production management system 10.

The monitoring system 30 includes an evaluation index collector 31 (a collector), a process selector 32 (a selector), and an adjustment instructor (an adjuster) 33, collects various types of evaluation indices output from the production management system 10, and issues an instruction to the production management system 10. The monitoring system 30 is used to stabilize the quality of a product to be produced (for example, the product PR to be produced in the production process P3 in FIG. 2) using a plurality of products produced independently of each other (for example, intermediate products produced in the production processes P1 and P2 in FIG. 2).

The evaluation index collector 31 collects various types of evaluation indices (the material evaluation index, the process evaluation index, the facility evaluation index, and the personnel evaluation index) output from the production management system 10. When the industrial process IP in which the product PR is produced from the material MT has a plurality of production processes, the evaluation index collector 31 collects the above-described various types of evaluation indices for each production process. For example, the evaluation index collector 31 collects the above-described various types of evaluation indices for the production processes P11 and P12 included in the production process P1, the production processes P21 and P22 included in the production process P2, and the production process P3 shown in FIG. 2.

The process selector 32 selects a production process required to be adjusted so that the quality of the product PR is stabilized in accordance with the evaluation indices collected by the evaluation index collector 31. Specifically, the process selector 32 selects at least one production process that has not been executed (or that will be executed) among the plurality of production processes included in the industrial process IP in which the product PR is produced from the material MT. This is because the production process, which has already been executed, cannot be adjusted.

For example, the process selector 32 selects at least one of the production process P12, the production process P22, and the production process P3 to be performed after the production process P21 in accordance with the evaluation index of the intermediate product produced in the production process P21 shown in FIG. 2. For example, when the evaluation index of the intermediate product produced in the production process P21 shown in FIG. 2 becomes within the predetermined allowable range but a deviation from a predetermined reference value is large, the process selector 32 selects a process having the large deviation. It is desirable for the process selector 32 to select an upstream production process if possible so that adjustment in a downstream production process is facilitated.

In the above-described example, the process selector 32 can select any production process (the production process P12, the production process P22, or the production process P3) to be performed after the production process P21. However, if it is difficult to stabilize the quality of the product PR even if the production process P3 is adjusted, at least one of the remaining production processes P12 and P22 from which the production process P3 is excluded may be selected.

The adjustment instructor 33 issues an instruction for adjusting the quality of the product to be produced in the production process selected by the process selector 32 to the production management system 10. By issuing such an instruction, the adjustment instructor 33 stabilizes the quality of the product PR to be finally produced in the industrial process IP. Specifically, the evaluation index of the product PR becomes within the predetermined allowable range and the deviation from the predetermined reference value is reduced. The adjustment instructor 33 may indicate only a target value to the production management system 10 or may issue an instruction for a specific content change of 4M.

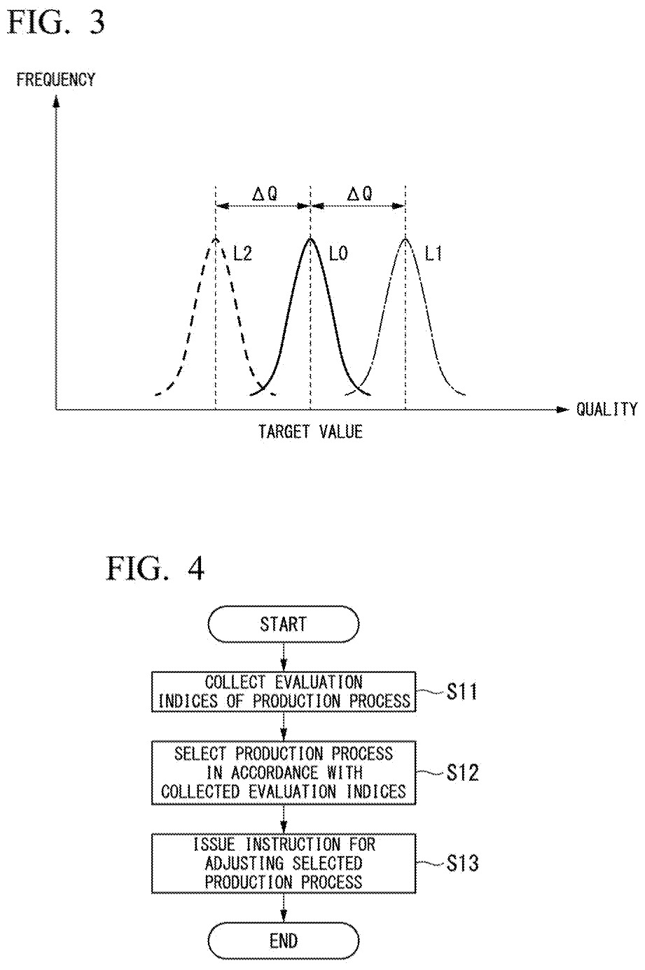

FIG. 3 is a diagram conceptually showing the adjustment performed according to the instruction of the adjustment instructor in the first embodiment of the present invention. In the graph shown in FIG. 3, the horizontal axis represents the quality of the product PR, and the vertical axis represents a frequency. As shown in FIG. 3, the product PR to be produced in the industrial process IP ideally has a median value of the quality as the target value, although some variation is allowed as indicated by a curve L0 in FIG. 3.

It is assumed that a standard intermediate product is produced in the production process P1 shown in FIG. 2 and it is assumed that the quality of the product PR produced from the standard intermediate product and the intermediate product capable of being produced through the production process P21 shown in FIG. 2 is likely to be indicated by a curve L1 of FIG. 3 (or is likely to have a deviation ΔQ from the target value). The adjustment instructor 33 issues an instruction for adjusting the production process (for example, the production process P12) selected by the process selector 32 to the production management system 10 so that the deviation ΔQ is canceled out.

By issuing this instruction, the above-described deviation ΔQ is canceled out and the product PR having the quality indicated by the curve L0 in FIG. 3 is produced. Assuming that a standard intermediate product is produced in the production process P2 shown in FIG. 2, the quality of the product PR produced from the standard intermediate product and the intermediate product capable of being produced through the production process P12 (an adjusted reproduction process) shown in FIG. 2 can be indicated, for example, by a curve L2 of FIG. 3 (can have a deviation ΔQ on the opposite side from the target value).

### <Quality Stabilization Method>

FIG. 4 is a flowchart showing a quality stabilization method according to the first embodiment of the present invention. The flowchart shown in FIG. 4 is started, for example, when the production of the product PR in the industrial process IP shown in FIG. 2 is started. When the flowchart shown in FIG. 4 is started, the evaluation index collector 31 of the monitoring system 30 collects the evaluation index of the production process (step S11: first step).

For example, in the industrial process IP shown in FIG. 2, the production process P11 of producing an intermediate product using the material MT1 is first performed. Thus, the evaluation index collector 31 collects an evaluation index of the intermediate product produced in the production process P11. Next, in the industrial process IP shown in FIG. 2, the production process P21 for producing an intermediate product using the material MT2 is performed. Thus, the evaluation index collector 31 collects the evaluation index of the intermediate product produced in the production process P21.

Here, it is assumed that the evaluation index of the intermediate product produced in the production process P21 indicates that the evaluation index of the intermediate product becomes within the predetermined allowable range but has a large deviation from the predetermined reference value. The process selector 32 selects at least one production process that has not been executed (or that will be executed) among the plurality of production processes included in the industrial process IP so that the quality of the product PR is stabilized (step S12: second step).

Specifically, the process selector 32 selects at least one of the production process P12, the production process P22, and the production process P3 that will be performed after the production process P21 shown in FIG. 2. Here, it is assumed that the production process P12 is selected for easy understanding. The adjustment instructor 33 issues an instruction for adjusting the quality of the product to be produced in the production process P12 selected by the process selector 32 to the production management system 10 (step S13: third step).

For example, as described above with reference to FIG. 3, it is assumed that the quality of the product PR produced from the standard intermediate product capable of being produced in the production process P1 shown in FIG. 2 and the intermediate product capable of being produced through the production process P21 shown in FIG. 2 is likely to be indicated by the curve L1 of FIG. 3 (or is likely to have the deviation ΔQ from the target value). The adjustment instructor 33 issues an instruction for adjusting the production process P12 selected by the process selector 32 to the production management system 10 so that the deviation ΔQ is canceled. By issuing this instruction, the above-described deviation ΔQ is canceled and the product PR having the quality indicated by the curve L0 in FIG. 3 is produced.

As described above, in the present embodiment, each of evaluation indices for evaluating the qualities of intermediate products produced in the production processes P1 and P2 independent of each other is first collected. Next, at least one of the production processes P1 and P2 and the production process P3 (the process of producing the product PR using the intermediate products produced in the production processes P1 and P2) is selected in accordance with the collected evaluation index. The quality of the product produced in the selected production process is adjusted. Thereby, it is possible to stabilize the quality of the product PR to be produced by combining a plurality of intermediate products produced through the production processes P1 and P2 independent of each other.

### [Second Embodiment]

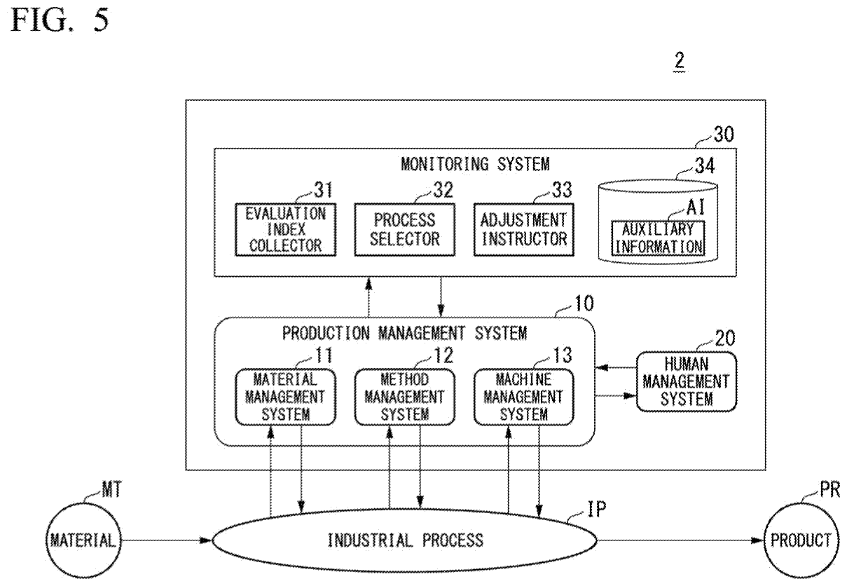

FIG. 5 is a block diagram showing a main configuration of a quality stabilization system according to a second embodiment of the present invention. As shown in FIG. 5, a quality stabilization system 2 of the present embodiment has a configuration in which a storage device 34 for storing auxiliary information AI is added to the monitoring system 30 of the quality stabilization system 1 shown in FIG. 1. This quality stabilization system 2 is configured so that the process selector 32 and the adjustment instructor 33 of the monitoring system 30 make the production process selection and the production process adjustment instruction using the auxiliary information AI obtained from previous results in the industrial process IP, respectively.

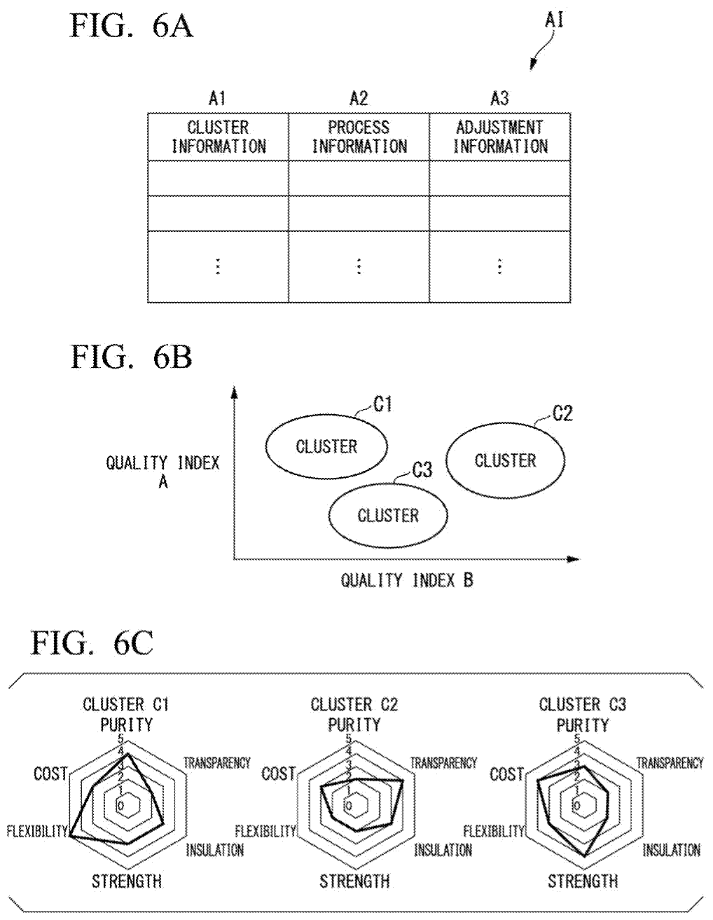

FIG. 6A, FIG. 6B, and FIG. 6C are diagrams for describing auxiliary information used in the second embodiment of the present invention. FIG. 6A is a diagram showing an example of the auxiliary information AI, FIG. 6B is a diagram for describing a cluster in the auxiliary information AI, and FIG. 6C is a diagram for describing a trend of an evaluation index in the cluster. As shown in FIG. 6A, the auxiliary information AI is information in which cluster information A1 (first information), process information A2 (second information), and adjustment information A3 (third information) are associated and, for example, is stored in the storage device 34 in the form of a table.

The cluster information A1 is information indicating a classification (a cluster) of the evaluation index obtained by classifying the evaluation indices of the intermediate products previously produced in the industrial process IP in accordance with degrees of similarity. Here, as shown in FIG. 6B, the cluster can be expressed as a set of products having a high degree of similarity in the evaluation indices in each axis in a space where a plurality of evaluation indices are designated as axes. In the example shown in FIG. 6B, three clusters C1 to C3 are shown.

Because a cluster is expressed as a set of products having a high degree of similarity in a plurality of evaluation indices as described above, the evaluation indices of products included in one cluster have a similar trend. For example, as shown in FIG. 6C, it is assumed that the product evaluation indices include “purity,” “transparency,” “insulation,” “strength,” “flexibility,” and “cost.” In a cluster C1 shown in FIG. 6C, values of “purity” and “flexibility” tend to be larger than the values of other evaluation indices. In a cluster C2 shown in FIG. 6C, a value of “transparency” tends to be larger than the values of other evaluation indices. In a cluster C3 shown in FIG. 6C, values of “cost” and “strength” tend to be larger than the values of other evaluation indices.

The process information A2 is information representing a production process to be selected by the process selector 32. This process information A2 is determined from previous results in the industrial process IP. That is, when the intermediate product included in the cluster indicated by the cluster information A1 has been previously produced, the information representing the production process on which the adjustment has been actually performed is used as the process information A2.

Adjustment information A3 is information representing an adjustment method to be performed by the adjustment instructor 33. The adjustment information A3 is determined from previous results in the industrial process IP as in the process information A2. That is, when the intermediate product included in the cluster represented by the cluster information A1 has been previously produced, the information representing the adjustment method that has been actually performed is used as the adjustment information A3.

The process selector 32 determines a cluster to which the evaluation index collected by the evaluation index collector 31 belongs. The process selector 32 selects a production process from the auxiliary information AI shown in FIG. 6 on the basis of the process information A2 associated with the cluster information A1 representing the determined cluster. The adjustment instructor 33 indicates the adjustment method in the production process selected by the process selector 32 on the basis of the adjustment information A3 associated with the cluster information A1 representing the determined cluster from the auxiliary information AI shown in FIG. 6 using a determination result of the process selector 32.

As described above, in the present embodiment, as in the first embodiment, each of evaluation indices for evaluating the qualities of intermediate products produced in the production processes P1 and P2 independent of each other is first collected. Next, a cluster to which the collected evaluation index belongs is determined. Subsequently, in the auxiliary information AI, the production process is selected on the basis of the process information A2 associated with the cluster information A1 representing the determined cluster. The auxiliary information AI represents the adjustment method in the selected production process on the basis of the adjustment information A3 associated with the cluster information A1 representing the determined cluster.

Thereby, it is possible to stabilize the quality of the product PR produced by combining a plurality of intermediate products produced through the production processes P1 and P2 independent of each other. Also, in the present embodiment, the selection of the production process in the process selector 32 and the adjustment instruction in the adjustment instructor 33 are made using the auxiliary information AI obtained from previous results in the industrial process IP. Thereby, the quality of the product PR can be stabilized more safely than in the first embodiment.

### [Third Embodiment]

A quality stabilization system of the present embodiment has a configuration roughly similar to that of the quality stabilization system 1 of the first embodiment.

That is, the quality stabilization system of the present embodiment also includes a production management system 10, a human management system 20, and a monitoring system 30 and is a system that stabilizes the quality of a product PR produced in an industrial process IP. However, because the industrial process IP that is a control target of the quality stabilization system of the present embodiment is different from that of the first embodiment (see FIG. 2), an operation different from that of the first embodiment is performed.

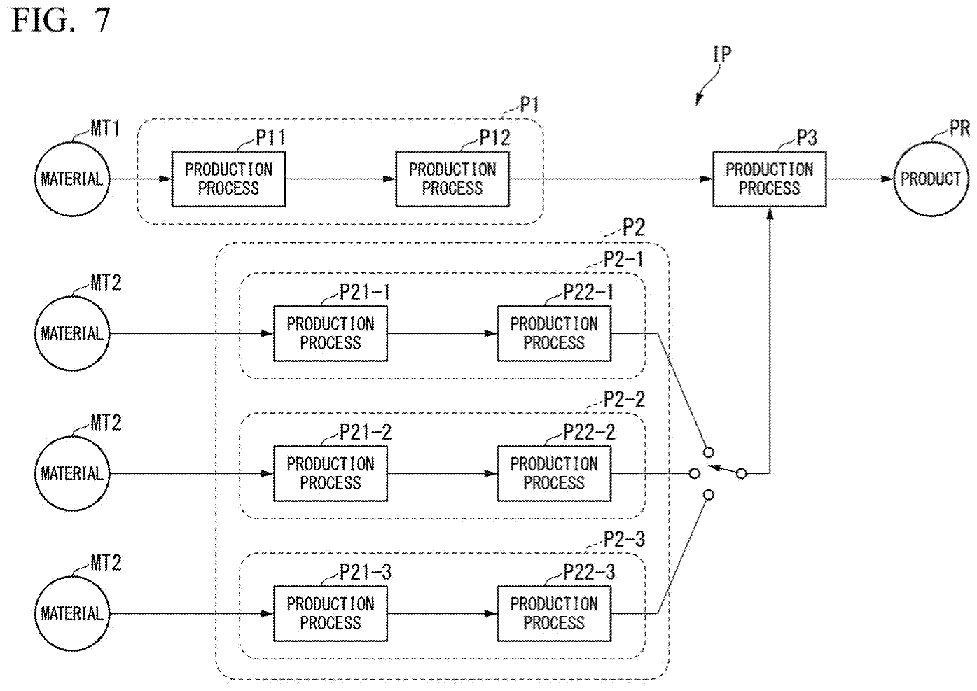

FIG. 7 is a diagram showing an example of production processes included in the industrial process according to the third embodiment of the present invention. A difference between the industrial process IP shown in FIG. 7 and the industrial process IP shown in FIG. 2 is that a production process P2 for producing an intermediate product (a second product) from a material MT2 has a plurality of production processes P2-1, P2-2, and P2-3 to be performed in parallel in the industrial process IP shown in FIG. 7.

The production process P2-1 has production processes P21-1 and P22-1 (a production process group) to be sequentially executed in series. The production process P2-2 has production processes P21-2 and P22-2 (a production process group) to be sequentially executed in series. Likewise, the production process P2-3 has production processes P21-3 and P22-3 (a production process group) to be sequentially executed in series. Although the same intermediate product is produced from the material MT2 in these production processes P2-1, P2-2, and P2-3, a variation in 4M causes a variation in the quality of the produced intermediate product.

In the present embodiment, the evaluation index collector 31 of the monitoring system 30 collects various types of evaluation indices for each of the production processes P11 and P12 included in the production process P1, the production processes P21-1 to P21-3 and P22-1 to P22-3 included in the production processes P2-1 to P2-3, and the production process P3 shown in FIG. 7. The process selector 32 of the monitoring system 30 selects the production process P2 in accordance with the evaluation index in the production process P1 (the evaluation index of the intermediate product produced in the production process P1) collected by the evaluation index collector 31.

The adjustment instructor 33 issues an instruction for causing any one of a plurality of production processes P2-1 to P2-3 included in the production process P2 selected by the process selector 32 to be selected in accordance with the evaluation index collected by the evaluation index collector 31. When such an instruction is issued, any one of the intermediate products to be produced in the plurality of production processes P2-1 to P2-3 is selected as the intermediate product to be produced in the production process P2. In this manner, the adjustment instructor 33 causes the quality of the intermediate product which is produced in the production process P2 selected by the process selector 32 to be adjusted.

As described above, in the present embodiment, each of evaluation indices for evaluating the qualities of intermediate products produced in the production processes P1 and P2 independent of each other is first collected. Next, the production process P2 is selected in accordance with the evaluation index of the intermediate product produced in the production process P1. An instruction for causing any one of a plurality of production processes P2-1 to P2-3 included in the selected production process P2 to be selected is issued. Thereby, it is possible to stabilize the quality of the product PR to be produced by combining a plurality of intermediate products produced through the production processes P1 and P2 independent of each other.

### <Implementation Example>

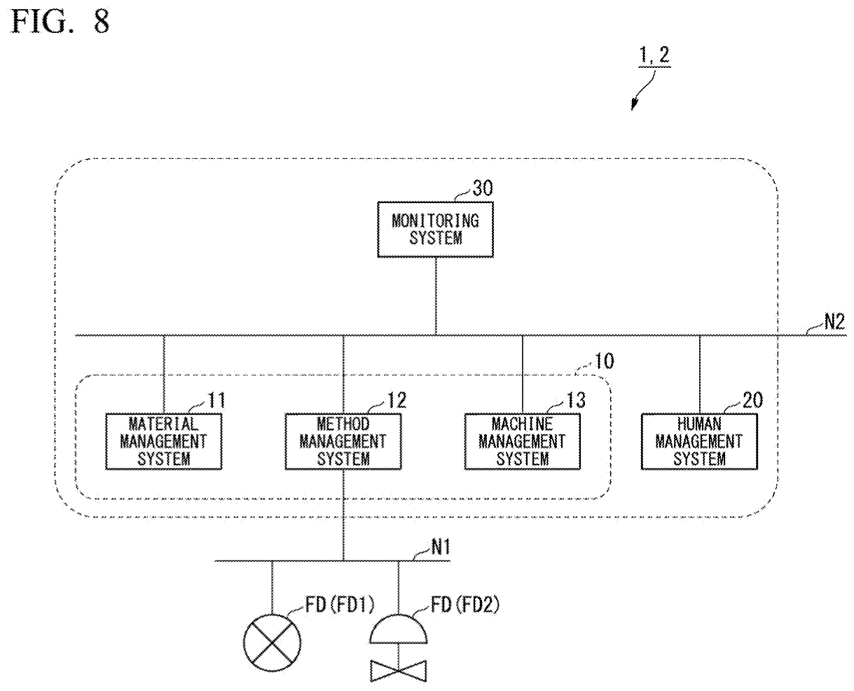

FIG. 8 is a block diagram showing an implementation example of a quality stabilization system according to an embodiment of the present invention. In FIG. 8, the same reference signs denote the blocks corresponding to the components shown in FIGS. 1 and 5. As shown in FIG. 8, the production management system 10 and the human management system 20 constituting the quality stabilization systems 1 and 2 are positioned above a field device FD.

Field devices FD include, for example, sensor devices such as a flow meter and a temperature sensor, valve devices such as a flow control valve and an on-off valve, actuator devices such as a fan and a motor, and other devices installed at the plant site. In FIG. 8, for easy understanding, only one sensor device FD1 for measuring a flow rate of a fluid and one valve device FD2 for controlling (operating) a flow rate of the fluid among a plurality of field devices FD installed in the plant are shown.

Plants that manage and control wells such as gas fields and oil fields and their surroundings, plants that manage and control power generation of hydropower, thermal power, nuclear power, and the like, plants that manage and control environmental power generation of solar power, wind power, and the like, plants that manage and control water and sewage and dams, and the like are installed as plants in which field devices FD are installed in addition to industrial plants such as chemicals. The above-described plants are merely examples and the present invention are not limited to the above-described plants.

The field device FD and the method management system 12 provided in the production management system 10 are connected via a network N1. Also, the material management system 11, the method management system 12, the machine management system 13, the human management system 20, and the monitoring system 30 provided in the production management system 10 are connected via a network N2. The network N1 is, for example, a wired network laid at the site of a plant. On the other hand, the network N2 is, for example, a wired network connected between a plant site and a monitoring room. The network Ni and the network N2 may be wireless networks.

Data obtained by the sensor device FDI (for example, data showing a result of measuring a flow rate of a fluid) is output to the method management system 12 via the network NI. Data generated by the method management system 12 (for example, data for controlling the flow rate of the fluid) is output to the valve device FD2 via the network NI. Also, evaluation indices generated by the material management system 11, the method management system 12, and the machine management system 13 provided in the production management system 10 and the human management system 20 are output to the monitoring system 30 via the network N2.

The monitoring system 30 is implemented by a computer such as a personal computer or a workstation. The functions of blocks of the monitoring system 30 (functions of the evaluation index collector 31, the process selector 32, the adjustment instructor 33, and the like) are implemented by executing a program for implementing each function on a computer. In other words, these functions are implemented by software and hardware resources in cooperation. For example, the program for implementing the function of each block of the monitoring system 30 may be distributed in a state in which the program is recorded on a computer-readable recording medium such as a CD-ROM or a DVD (registered trademark)-ROM or may be distributed via an external network such as the Internet.

Although the quality stabilization system, the quality stabilization method, and the quality stabilization program according to the embodiments of the present invention have been described above, the present invention is not limited to the above-described embodiments and modifications can be freely made within the scope of the present invention. For example, the quality stabilization systems 1 and 2 may be implemented by cloud computing. Here, the cloud computing may conform to the definition described in the documents specified by, for example, the following uniform resource locators (URLs), (the definition of recommendations of the National Institute of Standards and Technology).
http://nvlpubs.nist.gov/nistpubs/Legacy/SP/nistspecialpublication800-145.pdf
https://www.ipa.go.jp/files/000025366.pdf

(Supplementary Note)

According to an aspect of the present invention for solving the above-described problems, there is provided a quality stabilization system (1 or 2) for stabilizing quality of a third product (PR) to be produced in an industrial process (IP) having a first production process (P1), a second production process (P2), and a third production process (P3) which are independent of each other, a first product being produced in the first production process, a second product being produced in the second production process, the third product being produced using the first product and the second product in the third production process, the quality stabilization system may include a collector (31) configured to collect evaluation indices for evaluating qualities of the first product produced in the first production process and the second product produced in the second production process, a selector (32) configured to select at least one of the first production process, the second production process, and the third production process in accordance with the evaluation indices collected by the collector, and an adjuster (33) configured to adjust the quality of a product which is produced in a production process selected by the selector.

Also, according to an aspect of the present invention, in the quality stabilization system, the selector is configured to select at least one production process that has not been executed among the first production process, the second production process, and the third production process.

Also, according to an aspect of the present invention, in the quality stabilization system, each of the first production process and the second production process includes a production process group (P11, P12, P21, or P22) including a plurality of production processes to be sequentially executed in series, the collector is configured to collect the evaluation indices in the plurality of production processes constituting the production process group included in the first production process and the second production process, and the selector is configured to select at least one production process that has not been executed among the plurality of production processes constituting the production process group included in the first production process and the second production process.

Also, according to an aspect of the present invention, the quality stabilization system may further include a storage device configured to store auxiliary information (AI) in which first information (A1) representing a classification of the evaluation indices classified in accordance with a degree of similarity, second information (A2) representing a production process to be selected by the selector, and third information (A3) representing an adjustment method to be performed by the adjuster are associated, the selector is configured to select a production process based on the second information associated with the first information representing the classification of the evaluation indices collected by the collector in the auxiliary information, and the adjuster is configured to adjust quality of a product to be produced in the production process selected by the selector based on the third information associated with the first information representing the classification of the evaluation indices collected by the collector in the auxiliary information.

Also, according to an aspect of the present invention, in the quality stabilization system, the second production process includes a plurality of production process groups (P21-1, P22-1, P21-2, P22-2, P21-3, and P22-3) including a plurality of production processes to be sequentially executed in series, the collector is configured to collect the evaluation indices in a plurality of production processes constituting a plurality of production process groups included in the second production process, the selector is configured to select the second production process in accordance with the evaluation indices of the first production process collected by the collector, and the adjuster is configured to adjust quality of a product to be produced in the second production process selected by the selector by causing any one of the plurality of production process groups included in the second production process selected by the selector to be selected in accordance with the evaluation indices collected by the collector.

Also, according to an aspect of the present invention, in the quality stabilization system, the collector is configured to collect the evaluation indices from a production management system which controls the industrial process, and the adjuster is configured to issue an instruction for adjusting the quality of the product to be produced in the production process selected by the selector to the production management system.

Also, according to an aspect of the present invention, in the quality stabilization system, the adjuster is configured to issue the instruction to the production management system to make the evaluation indices of the third product become within a predetermined allowable range and to reduce a deviation from a predetermined reference value.

According to an aspect of the present invention, there is provided a quality stabilization method for stabilizing quality of a third product (PR) to be produced in an industrial process (IP) having a first production process (P1), a second production process (P2), and a third production process (P3) which are independent of each other, a first product being produced in the first production process, a second product being produced in the second production process, the third product being produced using the first product and the second product in the third production process, the quality stabilization method may include collecting (S11), by a collector (31), evaluation indices for evaluating qualities of the first product produced in the first production process and the second product produced in the second production process, selecting (S12), by a selector (32), at least one of the first production process, the second production process, and the third production process in accordance with the evaluation indices collected by the collector, and adjusting (S13), by an adjuster (33), the quality of a product which is produced in a production process selected by the selector.

Also, according to an aspect of the present invention, the quality stabilization method may further include selecting, by the selector, at least one production process that has not been executed among the first production process, the second production process, and the third production process.

Also, according to an aspect of the present invention, in the quality stabilization method, each of the first production process and the second production process includes a production process group (P21-1, P22-1, P21-2, P22-2, P21-3, and P22-3) including a plurality of production processes to be sequentially executed in series, and the quality stabilization method may further include collecting, by the collector, the evaluation indices in the plurality of production processes constituting the production process group included in the first production process and the second production process, and selecting, by the selector, at least one production process that has not been executed among the plurality of production processes constituting the production process group included in the first production process and the second production process.

Also, according to an aspect of the present invention, the quality stabilization method may further include storing, by a storage device, auxiliary information (AI) in which first information (A1) representing a classification of the evaluation indices classified in accordance with a degree of similarity, second information (A2) representing a production process to be selected by the selector, and third information (A3) representing an adjustment method to be performed by the adjuster are associated, selecting, by the selector, a production process based on the second information associated with the first information representing the classification of the evaluation indices collected by the collector in the auxiliary information, and adjusting, by the adjuster, quality of a product to be produced in the production process selected by the selector based on the third information associated with the first information representing the classification of the evaluation indices collected by the collector in the auxiliary information.

Also, according to an aspect of the present invention, in the quality stabilization method, the second production process includes a plurality of production process groups (P21-1, P22-1, P21-2, P22-2, P21-3, and P22-3) including a plurality of production processes to be sequentially executed in series, and the quality stabilization method may further include collecting, by the collector, the evaluation indices in a plurality of production processes constituting a plurality of production process groups included in the second production process, selecting, by the selector, the second production process in accordance with the evaluation indices of the first production process collected by the collector, and adjusting, by the adjuster, quality of a product to be produced in the second production process selected by the selector by causing any one of the plurality of production process groups included in the second production process selected by the selector to be selected in accordance with the evaluation indices collected by the collector.

Also, according to an aspect of the present invention, the quality stabilization method may further include collecting, by the collector, the evaluation indices from a production management system which controls the industrial process, and issuing, by the adjuster, an instruction for adjusting the quality of the product to be produced in the production process selected by the selector to the production management system.

Also, according to an aspect of the present invention, the quality stabilization method may further include issuing, by the adjuster, the instruction to the production management system to make the evaluation indices of the third product become within a predetermined allowable range and to reduce a deviation from a predetermined reference value.

According to an aspect of the present invention, there is provided a non-transitory computer readable storage medium storing a program executed by a computer of a quality stabilization system (1 or 2) for stabilizing quality of a third product (PR) to be produced in an industrial process (IP) having a first production process (P1), a second production process (P2), and a third production process (P3) which are independent of each other, a first product being produced in the first production process, a second product being produced in the second production process, the third product being produced using the first product and the second product in the third production process, the program may instruct the computer to collect (S11), by a collector (31), evaluation indices for evaluating qualities of the first product produced in the first production process and the second product produced in the second production process, select (S12), by a selector (32), at least one of the first production process, the second production process, and the third production process in accordance with the evaluation indices collected by the collector, and adjust (S13), by an adjuster (33), the quality of a product which is produced in a production process selected by the selector.

Also, according to an aspect of the present invention, in the non-transitory computer readable storage medium, the program may further instruct the computer to select, by the selector, at least one production process that has not been executed among the first production process, the second production process, and the third production process.

Also, according to an aspect of the present invention, in the non-transitory computer readable storage medium, each of the first production process and the second production process includes a production process group (P21-1, P22-1, P21-2, P22-2, P21-3, and P22-3) including a plurality of production processes to be sequentially executed in series, and the program may further instruct the computer to collect, by the collector, the evaluation indices in the plurality of production processes constituting the production process group included in the first production process and the second production process, and select, by the selector, at least one production process that has not been executed among the plurality of production processes constituting the production process group included in the first production process and the second production process.

Also, according to an aspect of the present invention, in the non-transitory computer readable storage medium, the program may further instruct the computer to store, by a storage device, auxiliary information (AI) in which first information (A1) representing a classification of the evaluation indices classified in accordance with a degree of similarity, second information (A2) representing a production process to be selected by the selector, and third information (A3) representing an adjustment method to be performed by the adjuster are associated, select, by the selector, a production process based on the second information associated with the first information representing the classification of the evaluation indices collected by the collector in the auxiliary information, and adjust, by the adjuster, quality of a product to be produced in the production process selected by the selector based on the third information associated with the first information representing the classification of the evaluation indices collected by the collector in the auxiliary information.

Also, according to an aspect of the present invention, in the non-transitory computer readable storage medium, the second production process includes a plurality of production process groups (P21-1, P22-1, P21-2, P22-2, P21-3, and P22-3) including a plurality of production processes to be sequentially executed in series, and the program may further instruct the computer to collect, by the collector, the evaluation indices in a plurality of production processes constituting a plurality of production process groups included in the second production process, select, by the selector, the second production process in accordance with the evaluation indices of the first production process collected by the collector, and adjust, by the adjuster, quality of a product to be produced in the second production process selected by the selector by causing any one of the plurality of production process groups included in the second production process selected by the selector to be selected in accordance with the evaluation indices collected by the collector.

Also, according to an aspect of the present invention, in the non-transitory computer readable storage medium, the program may further instruct the computer to collect, by the collector, the evaluation indices from a production management system which controls the industrial process, and issue, by the adjuster, an instruction for adjusting the quality of the product to be produced in the production process selected by the selector to the production management system.

According to the present invention, it is possible to stabilize quality of a product to be produced in accordance with a plurality of products produced through production processes independent of each other.

As used herein, the following directional terms “front, back, above, downward, right, left, vertical, horizontal, below, transverse, row and column” as well as any other similar directional terms refer to those instructions of a device equipped with the present invention. Accordingly, these terms, as utilized to describe the present invention should be interpreted relative to a device equipped with the present invention.

The term “configured” is used to describe a component, unit or part of a device includes hardware and/or software that is constructed and/or programmed to carry out the desired function.

Moreover, terms that are expressed as “means-plus function” in the claims should include any structure that can be utilized to carry out the function of that part of the present invention.

The term “unit” is used to describe a component, unit or part of a hardware and/or software that is constructed and/or programmed to carry out the desired function. Typical examples of the hardware may include, but are not limited to, a device and a circuit.

While preferred embodiments of the present invention have been described and illustrated above, it should be understood that these are examples of the present invention and are not to be considered as limiting. Additions, omissions, substitutions, and other modifications can be made without departing from the scope of the present invention.

Accordingly, the present invention is not to be considered as being limited by the foregoing description, and is only limited by the scope of the claims.

What is claimed is:

1. A quality stabilization system for stabilizing quality of a third product to be produced in an industrial process having a first production process, a second production process, and a third production process which are independent of each other, a first product being produced in the first production process, a second product being produced in the second production process, the third product being produced using the first product and the second product in the third production process, the quality stabilization system comprising:
a collector configured to collect evaluation indices for evaluating qualities of the first product produced in the first production process and the second product produced in the second production process;
a selector configured to select at least one of the first production process, the second production process, and the third production process in accordance with the evaluation indices collected by the collector; and
an adjuster configured to adjust the quality of a product which is produced in a production process selected by the selector.

2. The quality stabilization system according to claim 1,
wherein the selector is configured to select at least one production process that has not been executed among the first production process, the second production process, and the third production process.

3. The quality stabilization system according to claim 1,
wherein each of the first production process and the second production process includes a production process group including a plurality of production processes to be sequentially executed in series,
wherein the collector is configured to collect the evaluation indices in the plurality of production processes constituting the production process group included in the first production process and the second production process, and
wherein the selector is configured to select at least one production process that has not been executed among the plurality of production processes constituting the production process group included in the first production process and the second production process.

4. The quality stabilization system according to claim 1, further comprising:
a storage device configured to store auxiliary information in which first information representing a classification of the evaluation indices classified in accordance with a degree of similarity, second information representing a production process to be selected by the selector, and third information representing an adjustment method to be performed by the adjuster are associated,
wherein the selector is configured to select a production process based on the second information associated with the first information representing the classification of the evaluation indices collected by the collector in the auxiliary information, and
wherein the adjuster is configured to adjust quality of a product to be produced in the production process selected by the selector based on the third information associated with the first information representing the classification of the evaluation indices collected by the collector in the auxiliary information.

5. The quality stabilization system according to claim 1,
wherein the second production process includes a plurality of production process groups including a plurality of production processes to be sequentially executed in series,
wherein the collector is configured to collect the evaluation indices in a plurality of production processes constituting a plurality of production process groups included in the second production process,
wherein the selector is configured to select the second production process in accordance with the evaluation indices of the first production process collected by the collector, and
wherein the adjuster is configured to adjust quality of a product to be produced in the second production process selected by the selector by causing any one of the plurality of production process groups included in the second production process selected by the selector to be selected in accordance with the evaluation indices collected by the collector.

6. The quality stabilization system according to claim 1,
wherein the collector is configured to collect the evaluation indices from a production management system which controls the industrial process, and
wherein the adjuster is configured to issue an instruction for adjusting the quality of the product to be produced in the production process selected by the selector to the production management system.

7. The quality stabilization system according to claim 6,
wherein the adjuster is configured to issue the instruction to the production management system to make the evaluation indices of the third product become within a predetermined allowable range and to reduce a deviation from a predetermined reference value.

8. A quality stabilization method for stabilizing quality of a third product to be produced in an industrial process having a first production process, a second production process, and a third production process which are independent of each other, a first product being produced in the first production process, a second product being produced in the second production process, the third product being produced using the first product and the second product in the third production process, the quality stabilization method comprising:
collecting, by a collector, evaluation indices for evaluating qualities of the first. product produced in the first production process and the second product produced in the second production process;
selecting, by a selector, at least one of the first production process, the second production process, and the third production process in accordance with the evaluation indices collected by the collector; and
adjusting, by an adjuster, the quality of a product which is produced in a production process selected by the selector.

9. The quality stabilization method according to claim 8, further comprising:
selecting, by the selector, at least one production process that has not been executed among the first production process, the second production process, and the third production process.

10. The quality stabilization method according to claim 8,
wherein each of the first production process and the second production process includes a production process group including a plurality of production processes to be sequentially executed in series, and
wherein the quality stabilization method further comprises:
collecting, by the collector, the evaluation indices in the plurality of production processes constituting the production process group included in the first production process and the second production process; and
selecting, by the selector, at least one production process that has not been executed among the plurality of production processes constituting the production process group included in the first production process and the second production process.

11. The quality stabilization method according to claim 8, further comprising:
storing, by a storage device, auxiliary information in which first information representing a classification of the evaluation indices classified in accordance with a degree of similarity, second information representing a production process to be selected by the selector, and third information representing an adjustment method to be performed by the adjuster are associated;
selecting, by the selector, a production process based on the second information associated with the first information representing the classification of the evaluation indices collected by the collector in the auxiliary information; and
adjusting, by the adjuster, quality of a product to be produced in the production process selected by the selector based on the third information associated with the first information representing the classification of the evaluation indices collected by the collector in the auxiliary information.

12. The quality stabilization method according to claim 8,
wherein the second production process includes a plurality of production process groups including a plurality of production processes to be sequentially executed in series, and
wherein the quality stabilization method further comprises:
collecting, by the collector, the evaluation indices in a plurality of production processes constituting a plurality of production process groups included in the second production process;
selecting, by the selector, the second production process in accordance with the evaluation indices of the first production process collected by the collector; and
adjusting, by the adjuster, quality of a product to be produced in the second production process selected by the selector by causing any one of the plurality of production process groups included in the second production process selected by the selector to be selected in accordance with the evaluation indices collected by the collector.

13. The quality stabilization method according to claim 8, further comprising:
collecting, by the collector, the evaluation indices from a production management system which controls the industrial process; and
issuing, by the adjuster, an instruction for adjusting the quality of the product to be produced in the production process selected by the selector to the production management system.

14. The quality stabilization method according to claim 13, further comprising:
issuing, by the adjuster, the instruction to the production management system to make the evaluation indices of the third product become within a predetermined allowable range and to reduce a deviation from a predetermined reference value.

15. A non-transitory computer readable storage medium storing a program executed by a computer of a quality stabilization system for stabilizing quality of a third product to be produced in an industrial process having a first production process, a second production process, and a third production process which are independent of each other, a first product being produced in the first production process, a second product being produced in the second production process, the third product being produced using the first product and the second product in the third production process, the program instructing the computer to:
collect, by a collector, evaluation indices for evaluating qualities of the first product produced in the first production process and the second product produced in the second production process;
select, by a selector, at least one of the first production process, the second production process, and the third production process in accordance with the evaluation indices collected by the collector; and
adjust, by an adjuster, the quality of a product which is produced in a production process selected by the selector.

16. The non-transitory computer readable storage medium according to claim 15, wherein the program further instructs the computer to:
select, by the selector, at least one production process that has not been executed among the first production process, the second production process, and the third production process.

17. The non-transitory computer readable storage medium according to claim 15,
wherein each of the first production process and the second production process includes a production process group including a plurality of production processes to be sequentially executed in series, and
wherein the program further instructs the computer to:
collect, by the collector, the evaluation indices in the plurality of production processes constituting the production process group included in the first production process and the second production process; and
select, by the selector, at least one production process that has not been executed among the plurality of production processes constituting the production process group included in the first production process and the second production process.

18. The non-transitory computer readable storage medium according to claim 15, wherein the program further instructs the computer to:
store, by a storage device, auxiliary information in which first information representing a classification of the evaluation indices classified in accordance with a degree of similarity, second information representing a production process to be selected by the selector, and third information representing an adjustment method to be performed by the adjuster are associated;
select, by the selector, a production process based on the second information associated with the first information representing the classification of the evaluation indices collected by the collector in the auxiliary information; and
adjust, by the adjuster, quality of a product to be produced in the production process selected by the selector based on the third information associated with the first information representing the classification of the evaluation indices collected by the collector in the auxiliary information.

19. The non-transitory computer readable storage medium according to claim 15,
wherein the second production process includes a plurality of production process groups including a plurality of production processes to be sequentially executed in series, and
wherein the program further instructs the computer to:
collect, by the collector, the evaluation indices in a plurality of production processes constituting a plurality of production process groups included in the second production process;
select, by the selector, the second production process in accordance with the evaluation indices of the first production process collected by the collector; and
adjust, by the adjuster, quality of a product to be produced in the second production process selected by the selector by causing any one of the plurality of production process groups included in the second production process selected by the selector to be selected in accordance with the evaluation indices collected by the collector.

20. The non-transitory computer readable storage medium according to claim 15, wherein the program further instructs the computer to:
collect, by the collector, the evaluation indices from a production management system which controls the industrial process; and
issue, by the adjuster, an instruction for adjusting the quality of the product to be produced in the production process selected by the selector to the production management system.
